(19) United States
(12) Patent Application Publication
(10) Pub. No.: US 2019/0037895 A1
(43) Pub. Date: Feb. 7, 2019

(54) Molded Food Product and Method for Producing Same

(71) Applicant: Satomi SHIRAISHI, Brooklyn, NY (US)

(72) Inventor: Satomi SHIRAISHI, Brooklyn, NY (US)

(21) Appl. No.: 15/667,925

(22) Filed: Aug. 3, 2017

(51) Int. Cl. A23L 25/00; A23L 33/21

(52) U.S. Cl. CPC A23L 25/40; A23L 33/21; A23V 2250/208; A23V 2200/21; A23V 2300/10

(57) ABSTRACT

A molded food product which has an excellent shape retention property as well as causes little scorch of the ingredient, particularly carbonization of carbohydrates during production, and a method for producing such molded food product are provided. The molded food product contains a binder including a koji-fermented grain liquid composition. The fermented grain liquid composition is preferably amazake, sake cake, or mixtures thereof.

### TECHNICAL FIELD

The present disclosure relates to a molded food product convenient for carrying and eating, in particular, a molded food product made of edible food material pieces such as cereals, nuts, fruits and the like bound with a binder, and to a method for producing the same.

### BACKGROUND

Molded food products have been known in which edible food pieces such as cereals, nuts, fruits and the like are generally bonded with a binder and formed into a certain shape so as to be convenient for carrying or eating. Such molded food products are commercially available as cereal bars, nutrition bars, granola bars and the like.

Conventionally, sugar, starch syrup, gelatin, oils and the like have been used as binders in such molded food products. However, due to the growing health consciousness of consumers in recent years, there is a demand for molded food products that are made only from naturally-derived raw materials.

For example, Japanese Patent Application Publication No. 2009-136184 discloses a method for producing a molded food product made only from naturally-derived raw materials in which small pieces of dried fruits are heated to make their surfaces sticky, which allows the pieces of dried fruits to adhere to each other.

In addition, U.S. Pat. No. 7,629,008 discloses a cereal bar comprising a binder selected from the group consisting of sugar cane juice, brown rice syrup, caramel, oligofructose, inulin and a mixture thereof.

### SUMMARY

However, the molded food products described in these documents use carbohydrate compositions as binders and therefore have the following drawbacks. When a higher amount of the binder is used to improve the shape retention property of the molded food product, a higher processing temperature is required in order to reduce the moisture content of the molded food product, which makes the product scorched and carbonized. On the other hand, when the amount of the binder used is reduced to avoid the scorch, the molded food product is easily broken down into pieces in the mouth when consumed.

It is therefore an object of the present disclosure to solve these drawbacks and provide a molded food product containing a naturally-derived raw material as a binder which has an excellent shape retention property as well as causes little scorch of the ingredient, particularly carbonization of carbohydrates during production, and a method for producing the same.

In order to achieve the above object, the present disclosure relates to a molded food product comprising a binder including koji-fermented grain liquid composition. Koji is a filamentous fungus Aspergillus oryzae and is known to produce various enzymes such as amylase, cellulase, protease, pectinase and the like. Grain contains starch, which, when heated, is pregelatinized to increase its viscosity. The pregelatinized starch may be used as a glue to adhesively bind granules to each other. However, the pregelatinized starch is not suitable for a food binder due to its low fluidity and unfavorable taste. The present inventor has found that when grain is fermented with Aspergillus oryzae, the starch contained in the grain is partially decomposed into glucose by amylase produced by Aspergillus oryzae, appropriately increases its fluidity. When cooled, glucose is solidified to function as an excellent food binder together with residual starch.

Preferably, amazake (sweet sake) or sake cake, which is a by-product of Japanese rice wine, may be used as the koji-fermented grain liquid composition. It is noted that sake cake has low sugar and starch contents and thus is less adherent, so that amazake and/or conventional binders such as sugar, starch syrup, gelatin, fat and oil are preferably used in combination with sake cake.

The content of the binder is preferably 30% or more, more preferably 40% or more, particularly preferably 50% or more by weight with regard to the solid content of the finished product.

The moisture content of the molded food product according the present disclosure is preferably 20% or less, more preferably 15% or less, further preferably 8% or less.

The molded food product according the present disclosure may contain edible food pieces in addition to the binder. Such edible food pieces preferably have a mean particle diameter of 1.0 mm to 10.0 mm.

The present disclosure also provides a method for producing a molded food product bound by a binder, comprising the steps of: preparing a liquid raw material containing koji-fermented grain liquid composition as a binder; and dehydrating the liquid raw material. As mentioned above, the koji-fermented grain liquid composition contains sugar and starch, and has higher viscosity than that of a sugar solution with the same concentration, and better liquidity than that of the starch solution. As a result, the liquid raw material containing the koji-fermented grain liquid composition can be easily formed into a desired shape and can retain the desired shape. Starch is also decomposed into water-soluble dietary fiber by the action of the enzyme produced by koji. It is presumed that since the water-soluble dietary fiber is known to absorb water and turns into a gel-like mush, it also contributes to thicken the consistency of the koji-fermented grain liquid composition.

As the liquid raw material, amazake, sake cake, or a mixture thereof may be preferably used. The solid content of the liquid raw material is not particularly limited, but from the viewpoint of reducing the processing time required for dehydration, it is preferably 35% or more, and particularly preferably 40% or more.

The additive rate of the binder is preferably 30% or more, more preferably 40% or more, and particularly preferably 50% or more by weight with regard to the solid content of the final product.

The dehydration step is preferably carried out by forced-air drying. The forced-air drying is preferably performed at 40° C. to 71.1° C. (105° F. to 160° F.). This temperature range can prevent sugars and proteins contained in the liquid raw material from being carbonized during the dehydration step.

The dehydration step is continued until the moisture content of the molded food product is preferably 20% or less, more preferably 15% or less, and further preferably 8% or less.

The raw material thus dehydrated may be cut and formed into a desired shape to obtain a final product. Alternatively, the dehydration step may be carried out after the liquid raw material is placed in a given mold and formed into a shape corresponding to the final product.

According to the present disclosure, it is possible to provide a molded food product containing a naturally-derived raw material as a binder, which has an excellent shape retention property as well as causes little scorch of the ingredient, particularly carbonization of carbohydrates during production, and a method for producing the same.

### BRIEF DESCRIPTION OF THE DRAWINGS

In the accompanying drawing:

FIG. 1 shows appearances of molded food products produced under various dehydrating conditions.

### DETAILED DESCRIPTION

Exemplary embodiments of this disclosure are described below.

(1) Preparation of Liquid Raw Material Containing Koji-Fermented Grain

Raw grain is washed, mixed with an appropriate amount of water, and then cook according to a conventional procedure to gelatinize starch contained in the grain. Grain possibly used in this disclosure may include, but is not limited to, commonly eaten cereals, coarse cereals and pseudo cereals such as rice, wheat, barley, corn, rye, oats, Job's tears, foxtail millet, Japanese barnyard millet, proso millet, buckwheat, amaranth, quinoa, kaniwa and the like. In particular, from the viewpoint of flavor and texture, rice is preferably used.

The cooked grain is cooled down to 50° C. to 65° C. which is the optimum temperature range of amylase derived from koji, and then koji is inoculated to it. “Koji” as used herein is a fungus classified in the genus Aspergillus, preferably rice koji (Aspergillus oryzae) which has an excellent ability to produce an enzyme (amylase) capable of decomposing starch into glucose. Thereafter, while retaining the temperature within the optimum temperature range of amylase, the cooked grain is fermented to cause saccharification of starch until the sugar content reaches a sufficiently high level to act as a binder, preferably 35% or more, and more preferably 40% or more, thereby obtaining a koji-fermented grain liquid composition. In one embodiment, this temperature retention is continued for 8 to 12 hours.

A particularly preferred koji-fermented grain liquid composition is amazake. Amazake is a traditional Asian beverage that is made from steamed rice inoculated and fermented with Aspergillus oryzae to cause enzyme (amylase) derived from Aspergillus oryzae to saccharify starch in the steamed rice. Amazake is rich in glucose, oligosaccharides, B vitamins, essential amino acids, and has been noted as a nutritional supplement beverage in recent years.

Then, a given amount of edible food pieces such as cereals, nuts, fruits and the like are added to the koji-fermented grain liquid composition to obtain a liquid raw material. From the viewpoint of securing product formability and binding property, the content of the binder in the liquid raw material is preferably 30% or more, more preferably 40% or more, and particularly preferably 50% or more by weight with respect to the solid content of the final product. The upper limit of the binder content is not particularly limited. In the case where amazake, which serves as a nutrient source by itself, is used as the binder, the edible food pieces may be omitted and the content of amazake may be 100%. However, from the viewpoint of reducing the time required for dehydrating and molding the liquid raw material, the binder contend is preferably 80% or less.

Cereals, cereal flakes, cereal puffs, dried fruits, nuts, dietary fiber and the like may be used in whole or crushed form as the edible food pieces. Such food pieces preferably have a mean particle diameter of 1.0 mm to 10.0 mm. When the mean particle diameter is less than 1.0 mm, the texture of the product is inferior. On the other hand, when the mean particle diameter exceeds 10.0 mm, the edible food pieces are hardly bound to each other with the binder and thus the formability of the product is unlikely to be secured. Grain possibly used in this disclosure may include, but is not limited to, commonly eaten cereals, coarse cereals and pseudo cereals such as rice, wheat, barley, corn, rye, oats, Job's tears, foxtail millet, Japanese barnyard millet, proso millet, buckwheat, amaranth, quinoa, kaniwa and the like.

Optionally, the molded food product according to the present disclosure may include dairy products, egg products, cocoa powder, tea powder, fats, glycerin esters, sucrose esters, soybean lecithin and the like for the purpose of enhancing palatability. Furthermore, seasonings such as fruit pastes, flavors, and spices may be added, and vitamins and minerals may be use as a nutrient enhancer.

(2) Dehydration of the Liquid Raw Material

The liquid raw material thus prepared is spread in a flat plate having a uniform thickness, and placed in a dehydrator to be subjected to forced-air dehydration. The temperature condition adopted in the forced-air dehydration is preferably 40° C. to 70° C. (105° F. to 158° F.). When the air temperature is less than 40° C., the dehydration step requires longer time, and microorganisms may grow during the dehydration step to impair the flavor of the product. On the other hand, when the air temperature exceeds 70° C., the free sugars and free proteins contained in the liquid raw material may be carbonized by the heat to scorch the surface, resulting deterioration of the appearance and flavor qualities of the final product.

The duration of the dehydration step may be appropriately determined according to the texture and the shelf life desired for the final product. In order to suppress the stickiness of the product and to provide physical properties suitable for a so-called finger food that is eaten with the hands, the dehydration step is continued until the moisture content preferably reaches 20% or less. The moisture content at the end of the dehydration step is more preferably 15% or less in order to ensure the crunchiness of the product, and further preferably 8% or less from the view point of lowering the water activity and increasing the shelf life.

(3) Molding the Product

The dehydrated composition having the desired moisture content is removed from the dehydrator, cut with a knife or the like, and formed into a desired shape to obtain a final product. It is noted that the liquid raw material may be poured into a given mold prior to the dehydration step to be formed into a shape corresponding to the final product, and then is subjected to the dehydration step to obtain the final product.

The above description merely shows a part of the embodiment of the present disclosure and these configurations may be modified or combined with each other modified without departing from the scope of the present disclosure.

### EXAMPLES

Next, the molded food products according to the present disclosure were experimentally produced and evaluated. The results will be explained below.

500 g of brown rice and 50 g of black rice were mixed, washed with water, and then immersed in water for 12 hours. Thereafter, 50 g of red quinoa and 50 g of kaniwa washed with water were added to the immersed brown and black rice. 1,300 ml of water was further added to them and the mixture was cooked according to a conventional method. The cooked mixture was mixed with 500 ml of hot water of 90° C. and stirred to give a porridge-like grain mixture. The grain mixture was then allowed to cool to 60° C.

500 g of dried koji mold (available from Mutual Trading Co., Los Angeles, Calif.) was mixed with hot water of 60° C., and allowed to cool for 30 minutes. The cooled koji mold was inoculated to cooked porridge-like grain mixture cooled to 60° C., and the mixture was kept at 60° C. for 12 hours to obtain a koji-fermented grain liquid composition. The sugar content of the koji-fermented grain liquid composition was 42% as measured by means of Portable Brix Refractometer (available from GoerTek).

90 ml of crushed nuts having a mean particle diameter in the range of 3.0 mm to 10.0 mm was added to 450 ml of the resulting koji-fermented grain liquid composition, and the mixture of the crushed nuts and the koji-fermented grain liquid composition was spread to have the thickness of 1.0 mm, and then cut into test pieces of 7.0 cm×14.0 cm.

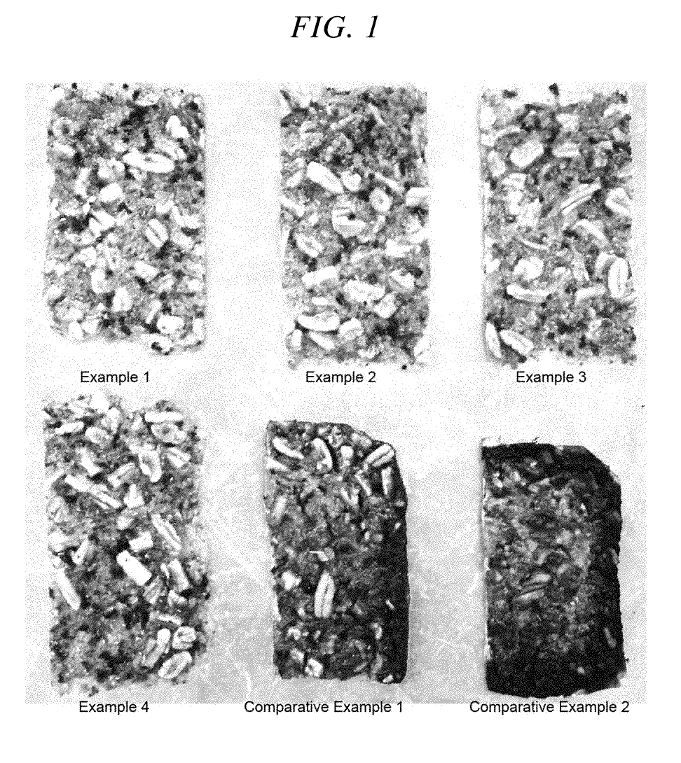

The test pieces were placed in a dehydrator (9-Tray Type manufactured by Excalibur Co, Sacrament, Calif.) and dried at the temperatures shown in Table 1 (Examples 1-4). For comparison, Comparative Examples 1 and 2 prepared in the same manner were placed in an electric oven and dried at the temperatures shown in Table 1. The appearances of the molded food products after the dehydration are shown in FIG. 1. As is apparent from the figure, the surfaces of Examples 1 to 4 retained the colors of the raw grain and nuts, whereas the surfaces of Comparative Examples 1 and 2 were scorched.

TABLE 1

| | | | | | Comp. | Comp. |
|---|---|---|---|---|---|---|
| | Ex. 1 | Ex. 2 | Ex. 3 | Ex. 4 | Ex. 1 | Ex. 2 |
| Air | 105° F. | 120° F. | 140° F. | 160° F. | 250° F. | 350° F. |
| Temp. | (40.6° | (48.9° | (60.0° | (71.1° | (121.1° | 176.7° |
| | C.) | C.) | C.) | C.) | C.) | C.) |

The molded food products thus obtained were organoleptically evaluated for texture and binding property by five panelists. The evaluation results are shown in Table 2.

TABLE 2

| | | | | | Comp. | Comp. |
|---|---|---|---|---|---|---|
| | Ex. 1 | Ex. 2 | Ex. 3 | Ex. 4 | Ex. 1 | Ex. 2 |
| Texture | Moist | Crispy | Crispy | Crunchy | Outside: | Outside: |
| | | | | | hard | hard |
| | | | | | Inside: | Inside: |
| | | | | | wet | wet |
| Scorch | No | No | No | No | Yes | Yes |
| Binding | Good | Good | Good | Good | Poor | Poor |
| Property | | | | | | |

The outer surfaces of Comparative Examples 1 and 2 were solidified rapidly at the early stage of the dehydration step to form crusts, which hindered smooth moisture transfer from the inside to the surface. As a result, the outer surfaces were hardened and scorched, and moisture was trapped inside the molded food products. In contrast, Examples 1 to 4 had better texture and biding property than those of Comparative Examples 1 and 2.

### Comparative Example 3

Sucrose was dissolved in water to prepare sucrose solution with 40% Brix. 90 ml of crushed nuts having a mean particle diameter in the range of 3.0 mm to 10.0 mm were added to 450 ml of the sucrose solution in the same manner as in Examples 1 to 3. The nut/sucrose mixed solution had high fluidity and could maintain a planner shape having the thickness of 1.0 cm. Instead, the nut/sucrose mixed solution was poured into a mold frame of 7.0 cm×14.0 cm and placed and dried in a dehydrator at 140° F. for 24 hours. The molded food product thus obtained was evaluated for texture and binding properties by fine panelist in the same manner with Example 3.

Example 3 had crispy texture while maintaining certain cohesiveness between nuts, and was evaluated to have preferable chewiness. Meanwhile, Comparative Example 3 was more brittle and less cohesive and when consumed, it was suddenly disintegrated in the mouth. All five panelists evaluated that Example 3 had better texture and taste. In addition, when Comparative Example 3 was held by hand, the sugar on the surface was dissolved and became sticky due to the body temperature. Contrarily, little or no melting was observed for Example 3, and it could be held by hand for a longer period.

1. A molded food product comprising a binder including a koji-fermented grain liquid composition.

2. The molded food product according to claim 1, wherein the fermented grain liquid composition is one selected from the group consisting of amazake, sake cake, and mixtures thereof.

3. The molded food product according to claim 1, wherein the content of the binder is 30% or more by weight with respect to the total solid content of the molded food product.

4. The molded food product according to claim 1, wherein the moisture content is 20% or less.

5. The molded food product according to claim 1, wherein the molded food product is dehydrated by air-drying at a temperature of 105° F. to 160° F.

6. The molded food product according to claim 1, further comprising edible food pieces having a mean particle diameter of 1.0 mm to 10.0 mm.

7. A method for producing a molded food product bound by a binder, comprising the steps of:
preparing a liquid raw material containing a koji-fermented grain liquid composition as the binder; and
dehydrating said liquid raw material.

8. The method according to claim 7, wherein the liquid raw material is one selected from the group consisting of amazake, sake cake, and mixtures thereof.

9. The method according to claim 7, wherein the solid content of the liquid raw material is 35% or more by weight.

10. The method according to claim 7, wherein the addition rate of the binder is 30% or more by weight with respect to the solid content of the molded food product.

11. The method according to claim 7, wherein the dehydration is carried out by forced-air drying.

12. The method according to claim 11, wherein the forced-air drying is carried out at a temperature of 105° F. to 160° F.

13. The method according to claim 7, wherein the moisture content of the molded food product after dehydration is 20% or less.

14. The method according to claim 7, further comprising cutting the dehydrated raw material into a desired shape.

15. The method according to claim 7, wherein the liquid raw material is charged in a mold to be formed into a shape corresponding to that of the molded food product prior to the step of dehydration.
